(19) United States
(12) Patent Application Publication
(10) Pub. No.: US 2010/0027549 A1
(43) Pub. Date: Feb. 4, 2010

(54) METHOD AND APPARATUS FOR PROVIDING VIRTUAL PRIVATE NETWORK IDENTIFIER

(76) Inventors: MICHAEL SATTERLEE, Clifton Park, NY (US); John F. Gibbons, Ballston Lake, NY (US); Neal A. Shackleton, Tierra Verde, FL (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/184,031

(22) Filed: Jul. 31, 2008

(51) Int. Cl. H04L 12/56

(52) U.S. Cl. 370/395.31

(57) ABSTRACT

A method and apparatus for providing for providing a Virtual Private Network (VPN) identifier on a packet network are disclosed. For example the method configures a provider edge (PE) router and a customer edge (CE) router with a set of link local labels for each virtual private network (VPN), wherein said set of link local labels is used to identify a VPN membership. The method also generates a master virtual route forwarding (VRF) table on the PE router for routes that are allowed into an interface to the CE router.

The present invention relates generally to communication networks and, more particularly, to a method and apparatus for providing a Virtual Private Network (VPN) identifier on a packet network, e.g., an Internet Protocol (IP) network.

### BACKGROUND OF THE INVENTION

An enterprise customer may build a Virtual Private Network (VPN) by connecting multiple sites or users over a service provider's network. A user may want to access multiple VPNs using the same physical access circuit. However, to provide such access, each VPN will consume Border Gateway Protocol (BGP) routing resources on both the Provider Edge (PE) and Customer Edge (CE) routers.

### SUMMARY OF THE INVENTION

In one embodiment, the present invention discloses a method and apparatus for providing a Virtual Private Network (VPN) identifier on a packet network, e.g., an Internet Protocol (IP) network. For example the method configures a provider edge (PE) router and a customer edge (CE) router with a set of link local labels for each virtual private network (VPN), wherein said set of link local labels is used to identify a VPN membership. The method also generates a master virtual route forwarding (VRF) table on the PE router for routes that are allowed into an interface to the CE router.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network with a Virtual Private Network (VPN) identifier;

FIG. 3 illustrates a flowchart of a method for providing a VPN identifier; and

FIG. 4 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for providing a Virtual Private Network (VPN) identifier on a packet network, e.g., an Internet Protocol (IP) network. Although the present invention is discussed below in the context of virtual private networks, the present invention is not so limited. Namely, the present invention can be applied for other networks in which addresses may be shared among specific set of users.

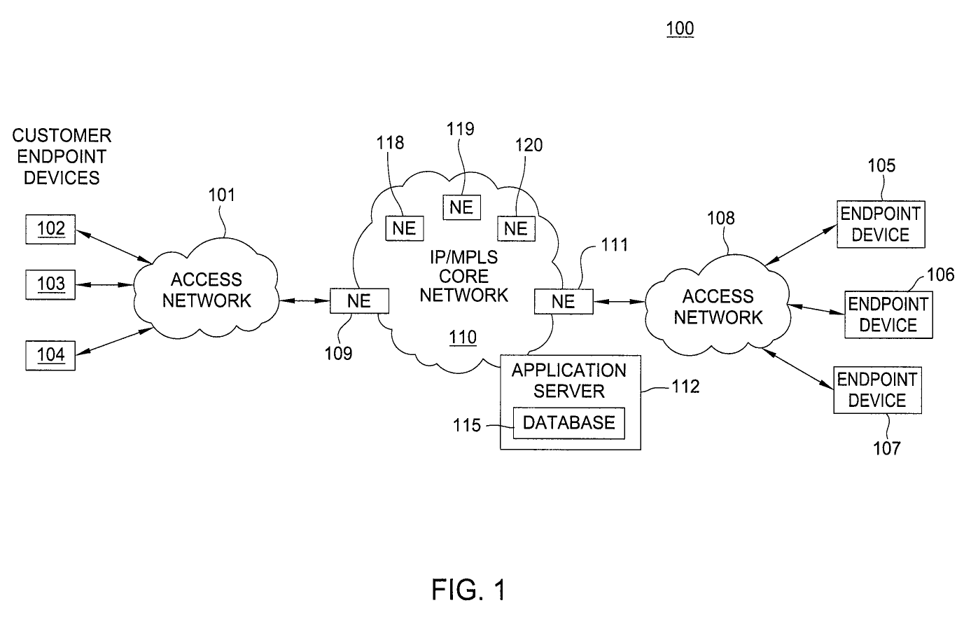

FIG. 1 is a block diagram depicting an exemplary packet network 100 related to the current invention. Exemplary packet networks include Internet protocol (IP) networks, Ethernet networks, and the like. An IP network is broadly defined as a network that uses Internet Protocol such as IPv4 or IPv6 and the like to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, honeypot, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, five network elements, and one application server are depicted in FIG. 1, the communication system 100 may be expanded by including additional endpoint devices, access networks, network elements, and application servers without altering the present invention.

The above IP network is described to provide an illustrative environment in which packets for voice and data services are transmitted on networks. In one embodiment, an enterprise customer may build a Virtual Private Network (VPN) by connecting multiple sites or users over a service provider's network. A VPN is a network in which a set of customer locations communicate over a service provider's network or the Internet in a private manner. The set of customer locations that may communicate with each other over a particular VPN are configured when the VPN is setup. That is, locations outside of the particular VPN are not allowed to intercept packets from the VPN or send packets over the VPN. Each VPN site has one or more Customer Edge (CE) routers attached to (i.e., in communication with) one or more Provider Edge (PE) routers. Each PE router attached to a CE router maintains a Virtual Route Forwarding (VRF) table for the VPN and forwards traffic among various VPN sites using the VRF table.

A user may access multiple VPNs using the same physical access circuit. For example, the customer may have multiple VPNs for various user groups, e.g., a group for a management community, a group for suppliers, a group for manufacturers, different groups for different product lines, and so on. However, a user may play multiple roles and may need to access multiple VPNs to perform various functions.

Each VPN is defined with a logical sub-interface that is mapped to a VRF table on a PE router. The provisioning of a logical sub-interface consumes interface descriptor blocks and Border Gateway Protocol (BGP) routing resources on both the PE and CE routers. One approach to mitigate using dedicated BGP routing resources between the CEs and PEs is to run Multi-Protocol Label Switching (MPLS) protocol between the customer and provider edge routers. This approach assumes that the PE sends all routes for all customer VPNs to the CE. However, the multiple VPNs may actually belong to different customers. Hence, the PE has to properly filter the routes and to send relevant routes only to the customer that is associated with the relevant interfaces on the PE. The filtering relies on a configuration that should be maintained with 100% accuracy. An error in configuration will result in exposing one customer's routes to another customer, which may have data security implications.

In one embodiment, the present invention discloses a method and apparatus for providing a Virtual Private Network (VPN) identifier on a packet network. The method provides MPLS labels (broadly referred to as link local labels) that have only local significance, e.g., the link local labels are only communicated between the PE and CE locally. In the description below, these MPLS labels are also referred to as link local MPLS labels. The PE and CE routers are configured with a set of link local MPLS labels. The link local MPLS labels are used to exchange routes between PE and CE routers and to ensure that each route is mapped to the correct VPN on the PE router.

In one embodiment, the method then builds a master VRF on the PE router for routes that can be allowed into the interface. The master VRF is based on the rule sets that are configured on an interface. For example, if an enterprise has four VPNs being accessed by users at a site, a master VRF that allows accessing all four VPNs at an interface is provided on the PE router. The master VRF may be provided per customer or per interface for a customer. That is, a master VRF contains routes only for one customer. Hence, the BGP protocol may be run per customer. Enabling customers to access multiple VPNs, using one BGP protocol session along with a master VRF table, reduces the BGP resource utilization on the PE and CE routers.

In one embodiment, the link local MPLS labels are distributed using a routing protocol such as BGP. In another embodiment, the link local MPLS labels are statically defined on both ends, i.e., on both the CE and PE routers. Since the labels have significance only locally, the same labeling scheme may be used across multiple customer VPNs and/or multiple access links.

The link local MPLS labels are applied by an egress interface to represent the VPN with which the packet is associated. For example, if the packet is transmitted from a PE to the CE, the PE router's egress interface applies the link local MPLS label to the packet. If the packet is transmitted from the CE to the PE, the CE router's egress interface applies the link local MPLS label to the packet. The interface builds label bindings only for routes that reside in VRFs that are part of its master VRF.

When a PE router receives a labeled packet from a CE router, the PE router uses the link local label to identify the VPN membership. For example, the PE router uses the link local MPLS label to identify the VRF and outbound interface of the next hop address associated with the originating PE. The PE then swaps the link local MPLS label for the VPN label to be used across the MPLS network.

When a PE router received a packet from the MPLS network destined towards a CE (i.e. the PE is an egress PE), the PE router identifies the VPN membership. The PE then swaps the VPN label of the packet for the link local MPLS label. The PE router then forwards the packet to the CE.

When the CE router receives a packet from the PE router, it identifies the VPN membership of the packet using the link local MPLS label. The CE router then removes the link local MPLS label and forwards the packet towards its destination using its associated virtual routing and forwarding instance for the identified VPN.

Note that the VPN label used across the MPLS network is a standard label and not restricted in terms of where it is significant. That is, the same VPN labeling scheme can not be used for multiple customers in the same MPLS network.

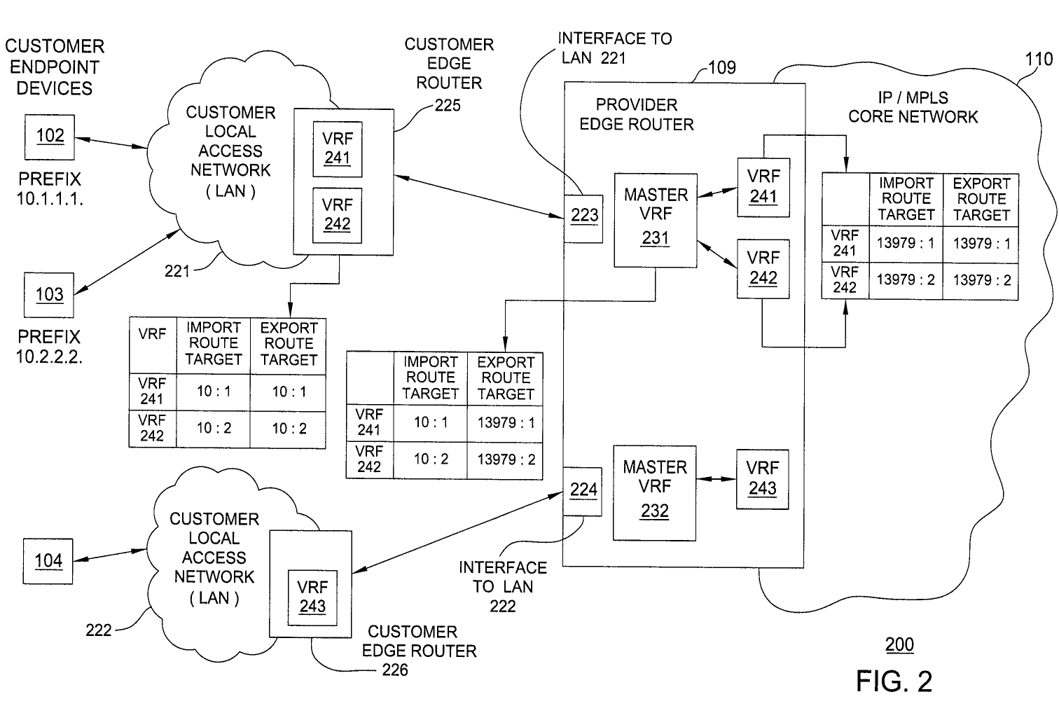

FIG. 2 provides an exemplary network 200 that provides VPN identifiers. The exemplary network 200 comprises two customer LANs 221 and 222 accessing services from an IP/MPLS core network 110 via a PE router 109. Customer endpoint devices 102 and 103 access VPN services from the IP/MPLS core network 110 via CE router 225 in LAN 221. Another customer endpoint device 104 accesses VPN services form the IP/MPLS core network 110 via CE router 226 in LAN 222. For example, customer endpoint devices 102 and 103 may belong to the same enterprise customer while the customer endpoint device 104 belongs to another enterprise customer. In the current example, customer endpoint devices 102 and 103 may be used to access two VPNs that belong to the same customer and may share an interface 223 on the PE router 109. Customer endpoint device 104 has a separate interface 224 on the PE router 109.

In one embodiment, the method builds VRFs 241 and 242 for the two VPNs accessed by customer endpoint devices 102 and 103. The method also builds a VRF 243 for the VPN accessed by customer endpoint device 104. The PE and CE routers are then configured with a set of link local MPLS labels. For example, the link local MPLS labels 10:1 and 10:2 are applied to routes in the VRF 241 and 242.

The method also builds a master VRF for each customer on the PE router 109 for routes that are allowed into an interface. For interface 223, master VRF 231 is populated with contents of VRFs 241 and 242. For example, the master VRF 231 is populated with the link local MPLS labels 10:1 and 10:2 and their respective actual VPN labels, 13979:1 and 13979:2. Since VRF 243 is not permitted for the interface 223, its routes are not included in the master VRF 231. A similar label may be applied for VRF 243 for routes that are allowed into interface 224 for a different customer.

The method then receives and processes packets based on the content of the master VRF for a customer ensuring that label bindings are created only for routes that reside in the master VRF for the interface. For example, the PE identifies the VPN membership of a packet received from a CE, swaps the link local MPLS label for the VPN label, and forwards the packet across the MPLS network towards its destination.

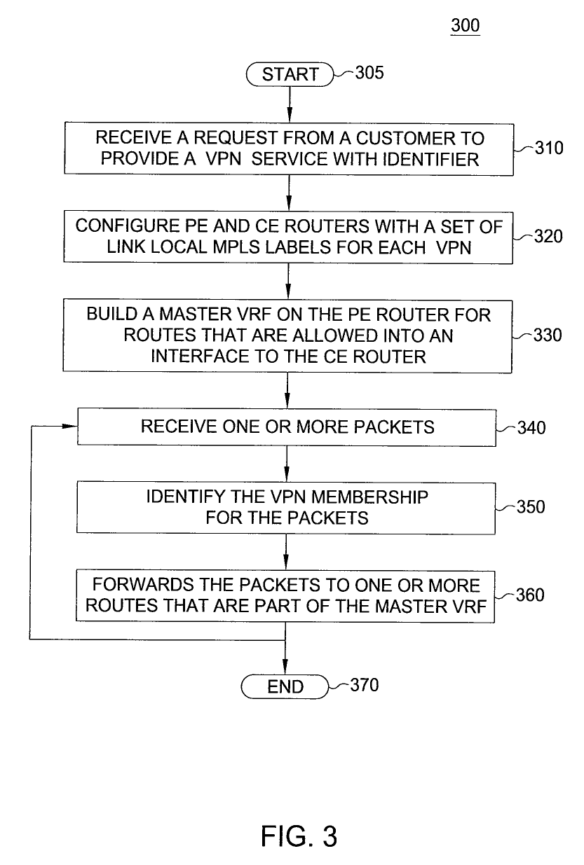

FIG. 3 illustrates a flowchart of a method 300 for providing a Virtual Private Network (VPN) identifier. For example, one or more steps of method 300 can be implemented by a PE. Method 300 starts in step 305 and proceeds to step 310.

In step 310, method 300 receives a request from a customer to provide a VPN service with identifier. For example, a customer may request that users be able to access multiple VPNs while sharing an interface on a PE router and using a BGP signaling between the CE and the PE.

In step 320, method 300 configures PE and CE routers with a set of link local MPLS labels for each VPN. For example, if a customer has two VPNs, two sets of link local MPLS labels are configured on the routers. Each VPN has its own VRF table. The specific format of the link local MPLS labels can be implemented in accordance with requirements dictated by the server provider and/or the customer. The present invention is not limited by the specific format of the link local MPLS labels.

In step 330, method 300 builds a master VRF for each customer (or for each interface if the interface is associated with a unique customer) on the PE router for routes that are allowed into an interface to a CE. For example, a master VRF may contain the contents of all VRFs that may share route information. For example, if an interface belongs to customer A, customer A may chose all users in customer A's LAN to be able to access one or more VPNs. The master VRF then contains all routes in the one or more VRFs for the customer. Another customer who may have a separate interface on the same PE will not be able to access the routes since the other customer's routes would be included in a separate master VRF.

In step 340, method 300 receives one or more packets. For example, the method receives a packet either from a CE to be forwarded towards the MPLS network or receives a packet from the MPLS network to be forwarded towards a CE.

in step 350, method 300 identifies the VPN membership for the packets. For example, if the packet is received from a CE router, the method identifies the VPN membership from the link local MPLS label. If the packet is received from the MPLS network, the method identifies the VPN membership from the standard VPN label.

In step 360, method 300 forwards the packets to one or more routes that are part of the master VRF. For example, if the packet is destined towards the CE router from the MPLS network, the method swaps the VPN label for the link local MPLS label and forwards it to the CE router if the route is in the master VRF. In another example, if the packet is received from the CE router, the method swaps the link local MPLS label for the VPN label and forwards the packet towards its destination. The method then ends in step 370 or returns to step 340 to continue receiving packets.

It should be noted that the above method supports either the use of static label distribution where the PE/CE are configured with static link local labels or a routing protocol such as BGP can be used to distribute the labels dynamically. One advantage of the above described method is that by only requiring one session per customer site without requiring logical sub-interfaces, the present approach reduces resource consumption on the edge network elements. Furthermore, the present approach does not require complex filters to be associated with the session between the PE and the CE, since only the routes associated with the pertinent VPN would be advertised.

It should be noted that although not specifically specified, one or more steps of methods 300 may include a storing, displaying and/or outputting step as required for a particular application. In other words, any data, records, fields, and/or intermediate results discussed in the method 300 can be stored, displayed and/or outputted to another device as required for a particular application. Furthermore, steps or blocks in FIG. 3 that recite a determining operation, or involve a decision, do not necessarily require that both branches of the determining operation be practiced. In other words, one of the branches of the determining operation can be deemed as an optional step.

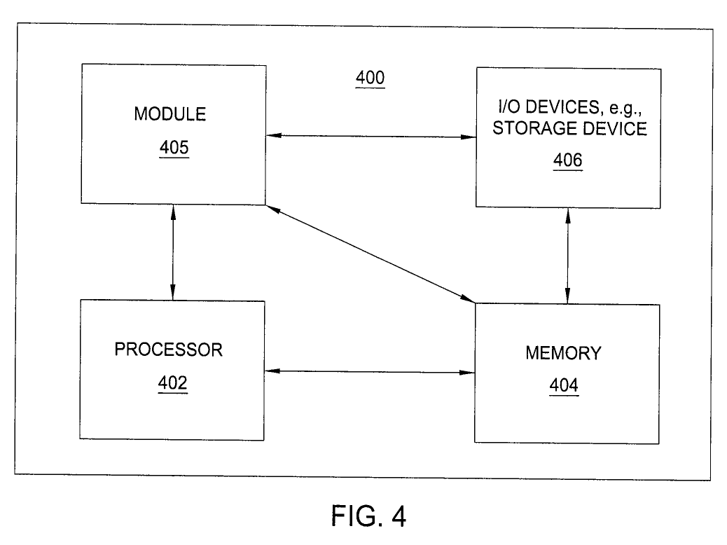

FIG. 4 depicts a high-level block diagram of a general-purpose computer suitable for use in performing the functions described herein. As depicted in FIG. 4, the system 400 comprises a processor element 402 (e.g., a CPU), a memory 404, e.g., random access memory (RAM) and/or read only memory (ROM), a module 405 for providing a Virtual Private Network (VPN) identifier on a packet network, and various input/output devices 406 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 405 for providing a VPN identifier on a packet network can be loaded into memory 404 and executed by processor 402 to implement the functions as discussed above. As such, the present method 405 for providing a VPN identifier on a packet network (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for providing a Virtual Private Network (VPN) identifier comprising:
configuring a provider edge (PE) router and a customer edge (CE) router with a set of link local labels for each virtual private network (VPN), wherein said set of link local labels is used to identify a VPN membership; and
generating a master virtual route forwarding (VRF) table on said PE router for routes that are allowed into an interface to said CE router.

2. The method of claim 1, further comprising:
receiving one or more packets;
identifying said VPN membership for said one or more packets in accordance with said set of link local labels; and
forwarding said one or more packets to one or more routes that are listed in said master VRF table.

3. The method of claim 1, wherein said link local labels are only exchanged between said PE and said CE.

4. The method of claim 1, wherein said master VRF is separately generated for each customer.

5. The method of claim 1, wherein said master VRF is separately generated for each interface on said PE.

6. The method of claim 1, wherein said link local labels are statically defined on said CE router and said PE router.

7. The method of claim 1, wherein said link local labels are distributed using a routing protocol.

8. The method of claim 7, wherein said routing protocol is a Border Gateway Protocol (BGP).

9. A computer-readable medium having stored thereon a plurality of instructions, the plurality of instructions including instructions which, when executed by a processor, cause the processor to perform the steps of a method for providing a Virtual Private Network (VPN) identifier, comprising:
configuring a provider edge (PE) router and a customer edge (CE) router with a set of link local labels for each virtual private network (VPN), wherein said set of link local labels is used to identify a VPN membership; and
generating a master virtual route forwarding (VRF) table on said PE router for routes that are allowed into an interface to said CE router.

10. The computer-readable medium of claim 9, further comprising:
receiving one or more packets;
identifying said VPN membership for said one or more packets in accordance with said set of link local labels; and
forwarding said one or more packets to one or more routes that are listed in said master VRF table.

11. The computer-readable medium of claim 9, wherein said link local labels are only exchanged between said PE and said CE.

12. The computer-readable medium of claim 9, wherein said master VRF is separately generated for each customer.

13. The computer-readable medium of claim 9, wherein said master VRF is separately generated for each interface on said PE.

14. The computer-readable medium of claim 9, wherein said link local labels are statically defined on said CE router and said PE router.

15. The computer-readable medium of claim 9, wherein said link local labels are distributed using a routing protocol.

16. An apparatus for providing a Virtual Private Network (VPN) identifier comprising:
means for configuring a provider edge (PE) router and a customer edge (CE) router with a set of link local labels for each virtual private network (VPN), wherein said set of link local labels is used to identify a VPN membership; and
means for generating a master virtual route forwarding (VRF) table on said PE router for routes that are allowed into an interface to said CE router.

17. The apparatus of claim 16, further comprising:
means for receiving one or more packets;
means for identifying said VPN membership for said one or more packets in accordance with said set of link local labels; and
means for forwarding said one or more packets to one or more routes that are listed in said master VRF table.

18. The apparatus of claim 16, wherein said link local labels are only exchanged between said PE and said CE.

19. The apparatus of claim 16, wherein said master VRF is separately generated for each customer.

20. The apparatus of claim 16, wherein said master VRF is separately generated for each interface on said PE.
